(19) United States
(12) Patent Application Publication
(10) Pub. No.: US 2014/0176956 A1
(43) Pub. Date: Jun. 26, 2014

(54) Super-Steep Step-Phase Interferometer

(71) Applicant: Optoplex Corporation, Fremont, CA (US)

(72) Inventor: Yung-Chieh Hsieh, San Jose, CA (US)

(21) Appl. No.: 14/088,385

(22) Filed: Nov. 23, 2013

Related U.S. Application Data
(60) Provisional application No. 61/730,467, filed on Nov. 27, 2012.

(51) Int. Cl. G01B 9/02

(52) U.S. Cl. CPC G01B 9/02027
USPC 356/477; 356/450

(57) ABSTRACT

Step-phase interferometers are provided for use as optical interleavers/de-interleaver for optical communication. High data rates require a wide band-width to pass the high-speed modulated optical spectrum, and further require a wide stop-band to reject the signal from adjacent channels. The present interferometers provide a steep slope at the transition from the passband to the adjacent stop-band, thereby enlarging the width of both the pass-band and stop-band.

### CROSS-REFERENCE TO RELATED APPLICATIONS

This application claims the benefit of U.S. Provisional Patent Application No. 61/730,467 titled “Super-Steep Step-Phase Interferometer,” filed Nov. 27, 2012, incorporated herein by reference.

### BACKGROUND OF THE INVENTION

1. Field of the Invention

The present invention relates to the design and use of step-phase interferometers as optical interleavers for optical communication., and more specifically, it relates to improvements that increase, the band-width and the stop-band of such interferometers, where the band-width allows passage of a high-speed modulated optic& spectrum and the stop-band rejects the signal from adjacent channels.

2. Description of Related Art

In dense wavelength division multiplexing (DWDM) optical communication, various frequencies (wavelengths) of laser light are coupled into the same optical fiber. The information capacity is directly proportional to the number of channels in the fiber. Since the total usable wavelength range is limited (about a few tens of nanometers), the smaller the channel spacing, the more channels can fit into the same optical fiber, therefore enabling more communication capacity.

The minimum possible channel spacing is limited by the capability of the multiplexer (MUX) and the de-multiplexer (de-MUX). Currently, the standard channel spacing is 100 GHz (0.8 nm). The manufacturing costs increase dramatically when the channel spacing is less than 100 GHz. A cost-effective method is desirable for interleaving channels thereby enabling the use of higher bandwidth filters with lower channel spacing in an optical communication system. For instance, one can use 100 GHz filters with 50 GHz channel spacing for using, a one-stage interleave. Furthermore, if a two-stage interleave is implemented, 100 GHz filters can be used in 25 GHz channel spacing communication system.

The Michelson interferometer shows the fundamental requirement of interleaving. However, it is not practical to apply such an interferometer to a real interleave device since it is too Sensitive to the central frequency and the line width alight source. If the frequency is slightly off from the integer, part of the optical power will leak from the bottom arm towards the left arm, causing, cross talk between channels. In other words, in order to make this device work, the laser line width should be zero and its central frequencies have to be perfectly locked over all the operation condition. Such frequency locking is very hard to achieve in the real world.

U.S. Pat. No. 6,587,204 provides an interleave device using an optical interferometer where one of the beams carries a linear phase and the other beam carries a non-linear phase such that the frequency dependence of the phase difference between these two interference beams at the bottom arm has a step-like function with step π. Under this condition, the frequency dependence of phase difference between the two interference beams at the left arm also has the same step-like function but is offset by π, as a result of energy conservation. Although the slope near 0- and π-phase difference is almost zero (horizontal), the slope at the transition from the 0-phase difference to π-phase difference is not very steep. The present invention increases the slope at the transition, thereby enlarging the width of both the pass-band and stop-band.

### SUMMARY OF THE INVENTION

A step-phase interferometer according to the teachings herein has an interferometer first arm including a linear phase offset spacer and a first resonant cavity, where the first resonant cavity is formed by a first partially reflective surface and a first mirror. An interferometer second arm has a second resonant cavity having a second partially reflective surface and a second mirror, where the optical path length of the first resonant cavity and the optical path length of the second resonant cavity are about equal. A beamsplitter has a splitting location configured to split an input beam of light into a first beam and a second beam, where the beamsplitter is configured to direct the first beam into the first arm, where the first beam will propagate first through the linear phase offset spacer and will then be reflected by the first resonant cavity to produce a first reflected beam that will then return to the beamsplitter, where the beamsplitter is configured to direct the second beam into the second arm, where the second beam will be reflected by the second resonant cavity to produce a second reflected beam that will then return to the beamsplitter and combine with the first beam.

The optical path difference from the splitting location to the first partially reflective surface and the second partially reflective surface is about half the optical path length of the first resonant cavity and where the frequency dependence of the phase difference between the first reflected beam and the second reflected beam has a step-like function. The step of the phase difference is approximately Π.

A method utilizing the step-phase interferometer described above includes providing an input beam, and splitting the input beam at the splitting location to produce a first beam and a second beam, where the beamsplitter directs the first beam into the first arm, where the first beam propagates first through the linear phase offset spacer and is then reflected by the first resonant cavity to produce a first reflected beam which returns to the beamsplitter, where the beamsplitter directs the second beam into the second arm, where the second beam is reflected by the second resonant cavity to produce a second reflected beam that then returns to the beamsplitter and combines with the first reflected beam, where the optical path difference from the splitting location to the first partially reflective surface and the second partially reflective surface is about half the optical path length of the first resonant cavity and where the frequency dependence of the phase difference between the first reflected beam and the second reflected beam has a step-like function. The step of the phase difference is approximately Π.

In another embodiment, an optical step-phase interferometer includes a beamsplitter to separate an incident beam of light into a first beam of light and a second beam of light; a linear phase offset spacer operatively positioned within the path of the first beam of light; a first non-linear phase generator (NLPG) operatively positioned to reflect the first beam of light, after the first beam of light passes through the linear phase offset spacer, to produce a first reflected beam; and a second non-linear phase generator (NLPG) operatively positioned to reflect the second beam of light to produce a second reflected beam, where the first reflected beam and the second reflected beam interfere with one another, where the frequency dependence of the phase difference between the first reflected beam and the second reflected beam has a step-like function. The step of the phase difference is approximately Π.

A method of interleaving frequencies of light is provided. The method includes separating, with a beamsplitter, an incident beam of light into a first beam of light and a second beam of light; passing the first beam of light through a linear phase offset spacer; reflecting the first beam of light with a first non-linear phase generator (NLPG), after the first beam of light passes through the linear phase offset spacer, to produce a first reflected beam; and reflecting the second beam of light with a second non-linear phase generator (NLPG) to produce a second reflected beam, where the first reflected beam and the second reflected beam interfere with one another, where the frequency dependence of the phase difference between the first reflected beam and the second reflected beam has a step-like function.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 is a schematic diagram of a step-phase interferometer

FIG. 2 shows the optical path of an interferometer as a De-mux.

FIG. 3A shows the phase difference of the T-channel as a function of frequency for a 50/100 G interleaver for the interferometer of FIG. 2.

FIG. 3B shows the corresponding power spectrum of the T-channel for the interferometer of FIG. 2.

FIG. 4 illustrates an embodiment of the present super-steep step-phase interferometer.

FIG. 5.A shows the phase difference of the two interference beams at one of the outputs of the interferometer of FIG. 4.

FIG. 5B shows the corresponding power spectrum of the T-channel for the interferometer of FIG. 4.

### DETAILED DESCRIPTION OF THE INVENTION

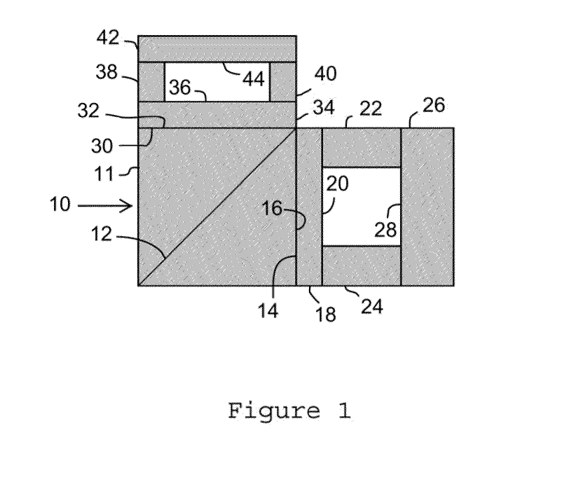

U.S. Pat. No. 6,587,204, incorporated herein by reference, describes embodiments of step-phase interferometers. FIG. 1 in the present case is a schematic diagram of an exemplary step-phase interferometer. The interferometer consists of a beam splitting cube 10 having an antireflection-coated input face 11 and a splitting interface 12. The right surface 14 is in optical contact, using optical contact bonding, with a first surface 16 of a transmissive optical element 18. Optical contact bonding is a glueless process whereby two closely conformal surfaces are joined together, being held purely by intermolecular forces. The second surface 20 of optical element 18 is configured such that it is partially reflective at a wavelength of interest. Second surface 20 is sometimes referred to herein as PR-1. Spacers 22 and 24 offset an element 26 from the first optical clement 18. Surface 28 of element 26 is configured to be reflective at the wavelengths of interest. Surface 28 is sometimes referred to herein as Mirror-1. In this design, surface 20 and surface 28 form a first resonant cavity, referred to herein as C-1, having a cavity length L. The upper surface 30 of cube 10 is in optical contact with a first surface 32 of a transmissive optical element 34. The second surface 36 of optical element 34 is coated with an antireflection coating. Spacers 38 and 40 offset an element 42 from optical element 34. Surface 44 of element 42 is configured to be reflective at the wavelengths of interest. Surface 44 is sometimes referred to herein as Mirror-2. The optical path difference from the splitting interface 12 to surface 44 and from the splitting interface 12 to partially reflective surface 20 is L/2. For a 50 G/100 G interleaver, the free spectral range (FSR) of C-1 is 50 GHz.

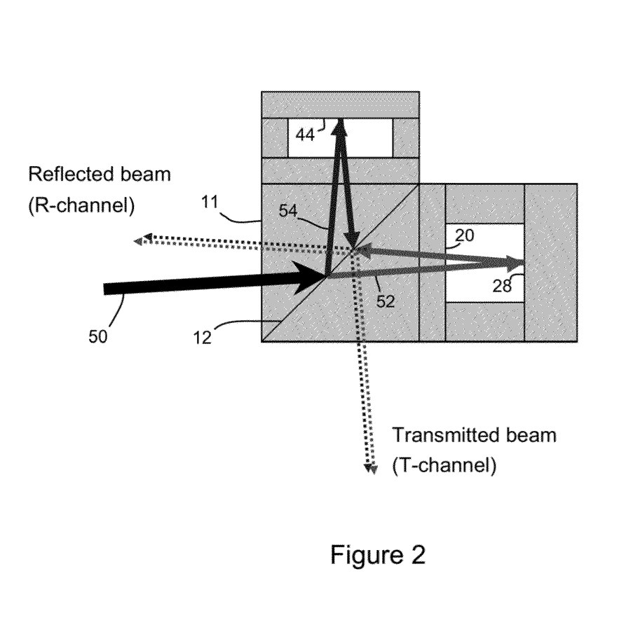

FIG. 2 shows the optical path of the interferometer of FIG. 1 used as a DE-MUX. This device is a 2-beam interference interferometer. The outputs to each of the R-channel and the T-channel are the results of two beams interfering constructively or destructively, depending on the wavelength. To make an interleaver, the phase difference, Δφ, between the two interference beams has to be 0 (i.e., 0 degree in phase) at the center of pass-band, and π (180 degree out of phase) at the center of stop-band. For instance, in a 50 G/100 G interleaver, Δφ is a function of normalized frequency, having a step-function response with a step size of π, and a period of 100 GHz.

In FIG. 2, an incident beam 50 enters the interferometer through surface 11 from the left of cube 10. The beam splitter 12 separates the beam into two puts (52 and 54). Beam part 52 is transmitted through the beam splitter 12 and then hits surface 29 (PR-1) and surface 28 (Mirror-1). Beam part 54 is reflected from the beam splitter 12 and then hits surface 44 (Mirror-2). Both beam part 52 and beam part 54 are reflected back to hit beam splitter 12 again. After hitting the beam-splitter a second time, beam part 52 and beam part 54 interfere constructively or destructively, depending on the wavelength. As a result, the power spectrum on the left-hand side (in the R-channel) is different from that obtained at the bottom of the interferometer (in the T-channel).

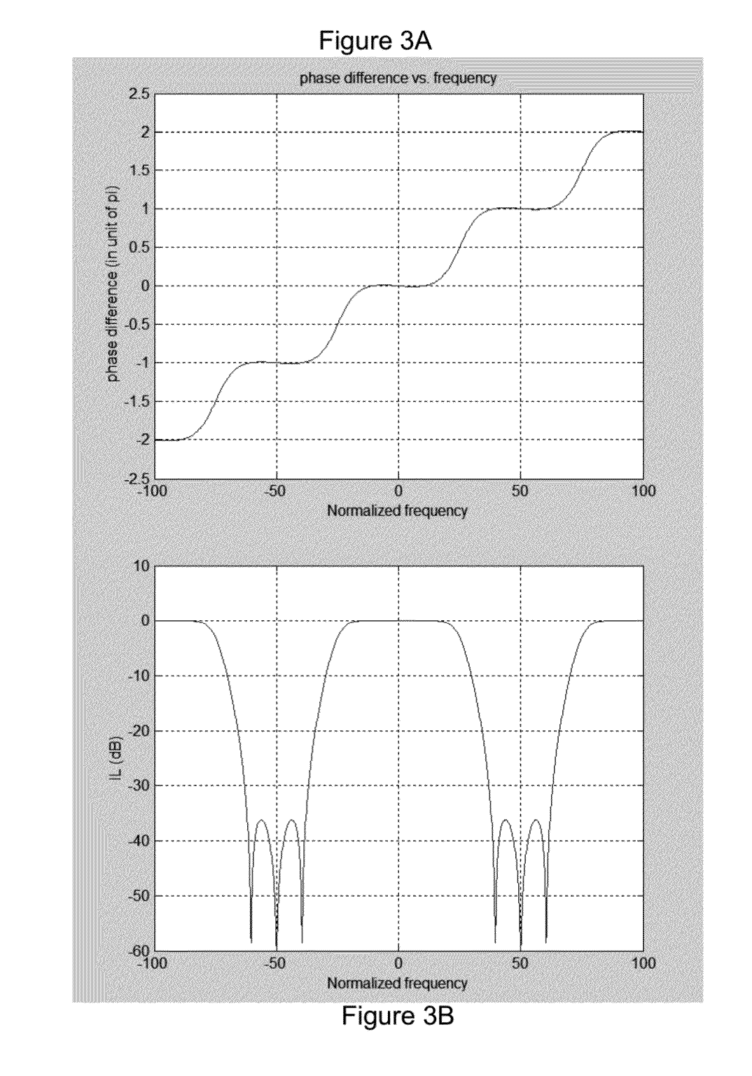

FIG. 3A shows the phase difference of the two interference beams of FIG. 2 at one of the two outputs. In this example, PR-1 (surface 20) is coated with 14% reflectivity. Due to energy conservation, the phase-difference at the other output is the same as that in FIG. 3A, but it is offset by π. FIG. 3B is the corresponding power spectrum showing that a beam with a frequency near multiple integers of 100 GHz transmits with almost no loss, and that of frequency near 50 G+N×100 G is blocked (where N is an integer).

Referring again to FIG. 3A, it can be observed that the slope near 0- and π-phase difference is almost zero (horizontal). But the slope at the transition from the 0-phase difference to π-phase difference is not very steep. The present invention increases the slope at the transition, thereby enlarging the width of both the pass-band and stop-band.

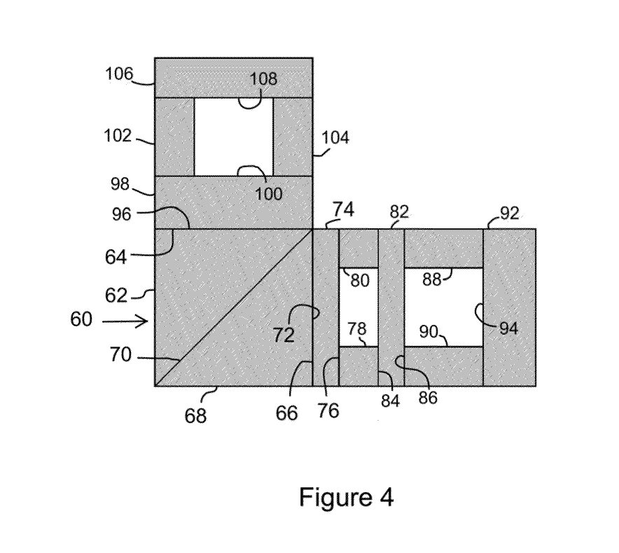

FIG. 4 shows an exemplary embodiment of the invention. The example embodiment includes a beam splitting cube 60 with a face 62 which can include an AR coating, an upper face 64 a right face 66, a lower face 68 which can include an AR coating, and a beamsplitting interface 70. Surface 72 of optically transmissive element 74 is in optical contact (i.e., optical contact bonding) with right face 66 of cube 60. Surface 76 of element 74 is AR coated. Spacers 78 and 80 offset an element 82 from element 74. These spacers are made of athermal material such as Zerodur, with CTE less than 0.3 ppm. As discussed below, spacers 78 and 80 function as a linear phase offset spacer element of the present interferometer. The material of element 82 is optically transparent and its surface 84 is AR coated. However, surface 86 of element 82 is partially reflective. Surface 86 is sometimes referred to herein as PR-1′. Note that in some embodiments, elements 74 and 82 are wedges which together cause surfaces 72 and 86 to he parallel and surfaces 76 and 84 to also be parallel. The purpose of the wedges is to eliminate or reduce ghost reflections. The wedges are formed by making surface 76 to be angled with respect to surface 72 and by making surface 84 to be angled with respect to surface 86. There is an air gap between surfaces 76 and 84. Spacers 88 and 90 offset an element 92 from element 82. These spacers are also made of athermal material. Surface 94 of element 92 is configured as a mirror and is sometimes referred to herein as Mirror-1′. In this embodiment, there is an air gap between surfaces 86 and 94.

Surface 96 of element 98 is in optical contact, by optical contact bonding, with upper face 64 of beamsplitting cube 60. Surface 100 of element 98 is configured to be partially reflective at wavelengths of interest. Surface 100 is sometimes referred to herein as PR-2′. Note that in this embodiment, the combined thickness of elements 74 and 82 is about equal to the thickness of element 98. Thus, the difference in the length of the upper arm and the right arm of this interferometer is determined by the length of spacers 78 and 80. Together spacers 78 and 80 function as a linear phase offset spacer element of the interferometer. Spacers 102 and 104 offset an element 106 from element 98. These spacers are formed of athermal material. Element 106 includes a surface 108 R as a mirror. Surface 108 is sometimes referred to herein as Mirror-2′. In this embodiment, there is an air gap between surfaces 100 and 108. U.S. Pat. No. 6,587,204 is incorporated herein by reference. Note that the common elements of U.S. Pat. No. 6,587,204 are aspects of and usable in embodiments of the present invention. Non-linear phase generators are described in the incorporated patent.

In this structure, surfaces PR-1′ and Mirror-r form a cavity C-1′ with a cavity length L. Similarly, surface PR-2′ and Mirror-2′ form cavity C-2′ also with a cavity length L. The relative cavity lengths of the two cavities are about equivalent (within a fraction of wavelength of the input light. The optical path difference from the beamsplitter to surface PR-1′ and from the beam splitter to PR-2′ is L/2. For a 50 G/100 G interleaver, the FSR of C-1′ and C-2′ is 50 GHz.

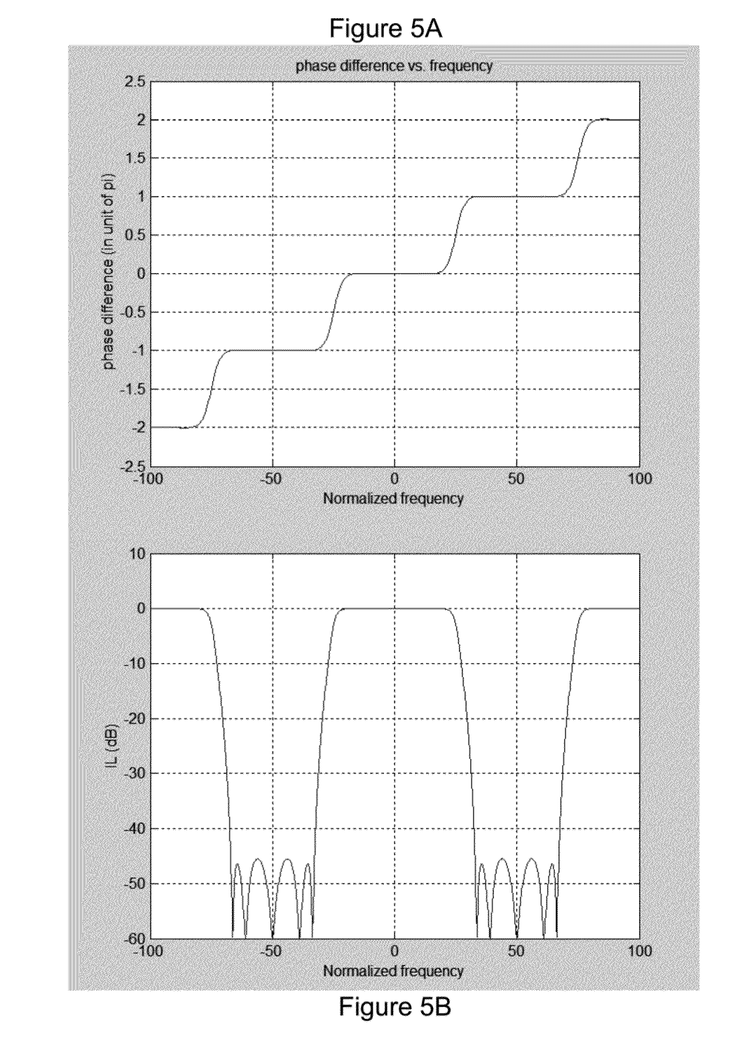

FIG. 5 shows Δφ and power spectrum at one of the outputs. In this example, the reflectivity of PR-1′ and PR-2′ is 42% and 3.5%, respectively. In comparison to FIG. 3A, FIG. 5A has a wider flat-region (horizontal) near 0- and π-phase difference and a steeper slope in the transition region. In other words, Δφ in FIG. 5A is much closer to an ideal step function than that in FIG. 3A. This results in a wider pass-band and stop-band as shown in FIG. 5B, compared with FIG. 3B. Thus, the interferometer structure shown in FIG. 4 significantly increases the width of the pass-band and the stop-band, which is important in a high-data rate optical communication system. The interfereometers described herein can be used as multiplexers and as demultiplexers.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim;

1. A step-phase interferometer, comprising:
an interferometer first arm comprising a linear phase offset spacer and a first resonant cavity, wherein said first resonant cavity is formed by a first partially reflective surface and a first mirror;
an interferometer second arm comprising a second resonant cavity having a second partially reflective surface and a second mirror, wherein the optical path length of said first resonant cavity and the optical path length of said second resonant cavity are about equal; and
a beamsplitter having a splitting location configured to split an input beam of light into a first beam and a second beam, wherein said beamsplitter is configured to direct said first beam into said first arm, wherein said first beam will propagate first through said linear phase offset spacer and will then be reflected by said first resonant cavity to produce a first reflected beam that will then return to said beamsplitter, wherein said beamsplitter is configured to direct said second beam into said second arm, where in said second beam will be reflected by said second resonant cavity to produce a second reflected beam that will then return to said beamsplitter and combine with said first beam;
wherein the optical path difference from said splitting location to said first partially reflective surface and said second partially reflective surface is about halt the optical path length of said first resonant cavity and wherein the frequency dependence of the phase difference between said first reflected been and said second reflected beam has a step-like function.

2. The optical step-phase interferometer of claim 1, wherein the step of said phase difference is approximately Π.

3. The step-phase interferometer of claim 1, wherein said linear phase offset spacer has a physical length sufficient to produce said optical path difference.

4. The step-phase interferometer of claim 1, wherein the free spectral range (FSR) of said first resonant cavity and said second resonant cavity are each about 50 GHz and wherein the FSR of said optical path difference is about 100 GHz.

5. The step-phase interferometer of claim 1, wherein the optical path length of said first resonant cavity and the optical path length of said second resonant cavity are within a fraction of a wavelength of each other, wherein said wavelength is that of the input beam.

6. The step-phase interferometer of claim 1, wherein said beamsplitter comprises an unpolarized beamsplitter.

7. The step-phase interferometer of claim 6, wherein said unpolarized beamsplitter comprises a symmetrical internal beam-splitting coating.

8. The step-phase interferometer of claim wherein said linear phase offset spacer comprises an AR coated surface offset with a first athermal spacer from a second AR coated surface, wherein said first partially reflective surface is offset with a second athermal spacer from said first minor and wherein said second partially reflective surface is offset with a third athermal spacer from said second mirror.

9. A method utilizing the step-phase interferometer of claim 1, comprising:
providing an input beam; and
splitting said input beam at said splitting location to produce a first beam and a second beam, wherein said beamsplitter directs said first beam into said first arm, wherein said first beam propagates first through said linear phase offset spacer arid is then reflected by said first resonant cavity to produce a first reflected beam which returns to said beamsplitter, wherein said beamsplitter directs said second beam into said second arm, wherein said second beam is reflected by said second resonant cavity to produce a second reflected beam that then returns to said beamsplitter and combines with said first reflected beam,
wherein the optical path difference from said splitting location to said first partially reflective surface and said second partially reflective surface is about half the optical path length of said first resonant cavity and wherein the frequency dependence of the phase difference between said first reflected beam and said second reflected beam has a step-like function.

10. The method of claim 9, wherein the step of said phase difference is approximately Π.

11. The method of claim 9, wherein said linear phase offset spacer has a physical length sufficient to produce said optical path difference.

12. The method of claim 9, wherein the free spectral range (FSR) of said first resonant cavity and said second resonant cavity are each about 50 GHz and wherein the FSR of said optical path difference is about 100 GHz.

13. The method of claim 9, wherein the length of said first resonant cavity and the length of said second resonant cavity are within a fraction of a wavelength of each other, wherein said wavelength is that of the input beam.

14. The method of claim 9, wherein said beamsplitter comprises an unpolarized beamsplitter.

15. The method of claim 14, wherein said unpolarized beamsplitter comprises a symmetrical internal beam-splitting coating.

16. The method of claim 9, wherein said linear phase offset spacer comprises an AR coated surface offset with a first athermal spacer from a second AR coated surface, wherein said first partially reflective surface is offset with a second athermal spacer from said first mirror and wherein said second partially reflective surface is offset with a third athermal spacer from said second mirror.

17. An optical step-phase interferometer, comprising:
a beamsplitter to separate an incident beam of light into a first beam of light and a second beam of light;
a linear phase offset spacer operatively positioned within the path of said first beam of light;
a first non-linear phase generator (NLPG) operatively positioned to reflect said first beam of light, after said first beam of light passes through said linear phase offset spacer, to produce a first reflected beam;
a second non-linear phase generator (NLPG) operatively positioned to reflect said second beam of light to produce a second reflected beam,
wherein said first reflected beam and said second reflected beam interfere with one another, wherein the frequency dependence of the phase difference between said first reflected beam and said second reflected beam has a step-like function.

18. The optical step-phase interferometer of claim 17, wherein the step of said phase difference is approximately Π.

19. The optical step-phase interferometer of claim 17, wherein the FSR of said first NLPG is about equal to the FSR of said second NLPG with a fraction of a wavelength.

20. The optical step-phase interferometer of claim 17, wherein the optical path length difference from said beamsplitter to said first NLPG and from said beam splitter to said second NLPG is about half of a cavity length of said first NLPG.

21. The optical step-phase interferometer of claim 17, wherein at least one of said first NLPG and said second NLPG comprises a plurality of partially reflecting surfaces and a reflective surface comprising nearly 100% reflectivity.

22. The optical step-phase interferometer of claim 17, wherein said first reflected beam and said second reflected beam are combined into two interference beams at said beam splitter, wherein a first interference beam of said two interference beams carries a first subset of signals and a second interference beam of said two interference beams carries a second subset of signals, wherein said first subset of signals is directed to a first port and said second subset of signals is directed to a second port.

23. The optical step-phase interferometer of claim 17, wherein said first NLPG comprises a first reflective surface and a second reflective surface that are separated, wherein said second NLPG comprises a third reflective surface and a fourth reflective surface that are separated.

24. The optical step-phase interferometer of claim 23, wherein said second reflective surface comprises nearly 100% reflectivity and wherein said fourth reflective surface comprises nearly 100% reflectivity.

25. The optical step-phase interferometer of claim 17, wherein said first NLPG comprises a cavity having an optical path length, wherein the optical path length difference (OPLD) between said beamsplitter to said first NLPG and from said beamsplitter to said second NLPG is approximately half of the optical path length of said cavity.

26. The optical step-phase interferometer of claim 17, further comprising a second beamsplitter positioned to combine said first reflected beam and said second reflected beam to interfere with each other, wherein said optical step-phase interferometer is configured as an optical interleaving Mach-Zehnder type step-phase interferometer.

27. The optical step-phase interferometer of claim 17, further comprising an input fiber optic to provide said incident beam.

28. The optical step-phase interferometer of claim 22, further comprising a first output fiber optic and a second output fiber optic, wherein said first output fiber optic is positioned at said first port to collect said first subset and wherein said second fiber optic is positioned at said second port to collect said second subset.

29. The optical step-phase interferometer of claim 17, further comprising at least one fiber optic positioned to collect a beam comprising the interference of said first reflected beam and second reflected beam.

30. The optical step-phase interferometer of claim 22, further comprising a circulator to redirect said first subset of optical signals into a first port.

31. A method of interleaving frequencies of light, comprising:
separating, with a beamsplitter, an incident beam of light into a first beam of light and a second beam of light;
passing, said first beam of light through a linear phase offset spacer,
reflecting said first beam of light with a first non-linear phase generator (NLPG), after said first beam of light passes through said linear phase offset spacer, to produce a first reflected beam:
reflecting said second beam of light with a second non-linear phase generator (NLPG) to produce a second reflected beam,
wherein said first reflected beam and said second reflected beam interfere with one another, wherein the frequency dependence of the phase difference between said first reflected beam and said second reflected beam has a step-like function.
